(19) United States
(12) Patent Application Publication
(10) Pub. No.: US 2007/0101804 A1
(43) Pub. Date: May 10, 2007

(54) Ultrasonic liquid viscosity sensor using mode conversion

(76) Inventor: Duncan Billson, Coventry (GB)

Correspondence Address: DOWNS RACHLIN MARTIN PLLC, 199 MAIN STREET, P O BOX 190, BURLINGTON, VT, 05402-0190, US

(21) Appl. No.: 10/566,336

(22) PCT Filed: Jul. 29, 2004
(86) PCT No.: PCT/GB04/03288

§ 371 Date: Jan. 16, 2007

(30) Foreign Application Priority Data
Jul. 29, 2003 (GB) 0317727.6

(51) Int. Cl. G01N 11/16

(52) U.S. Cl. 73/54.41

(57) ABSTRACT

The present invention provides a liquid viscosity sensor comprising an ultrasonic source, a sampling body and an ultrasonic receiver. The sampling body includes a sampling face contactable by a sample of liquid, in use. The source is operable to generate a longitudinal ultrasonic wave which follows a path through the body to the sampling face and onwards to the receiver. The body is configured such that the longitudinal wave emanating from the source is transformed into a horizontally polarised shear wave prior to reaching the sampling face, and the horizontally polarised shear wave is re-transformed into a longitudinal wave before reaching the receiver. There is provided a sensor adapted to utilise the interaction of a horizontally polarised shear wave at a liquid solid interface to measure viscosity, while eliminating the need to provide both a source and receiver configured to generate and receive horizontally polarised shear waves.

The present invention relates to a liquid viscosity sensor and in particular to a liquid viscosity sensor which utilises an ultrasonic transducer.

It is often a requirement to determine the viscosity of a liquid to, for example, ascertain the condition of the liquid. One particular field where viscosity measurement is important is combustion engine lubrication. It will be appreciated that, over time, a combustion engine lubricant becomes contaminated with unburned hydrocarbons, combustion by-products and particulate matter. These contaminants tend to alter the viscosity of the oil which in turn alters the flow rate of the oil.

According to a first aspect of the present invention there is provided a liquid viscosity sensor comprising an ultrasonic source, a sampling body and an ultrasonic receiver, the sampling body including a sampling face contactable by a sample of liquid, in use, the source being operable to generate a longitudinal ultrasonic wave which follows a path through the body to the sampling face and onwards to the receiver, wherein the body is configured such that the longitudinal wave emanating from the source is transformed into a horizontally polarised shear wave prior to reaching the sampling face, and the horizontally polarised shear wave is re-transformed into a longitudinal wave before reaching the receiver.

The present invention thus provides a sensor adapted to utilise the interaction of a horizontally polarised shear wave at a liquid solid interface to measure viscosity, while eliminating the need to provide both a source and receiver configured to generate and receive horizontally polarised shear waves.

In a preferred embodiment the transformation in the waves occurs at a common feature of the sampling body. The feature may comprise a reflection point of the body. The common feature may comprise a reflective face of the body. The face may be substantially planar. The face may be defined by a solid to air interface of the body. The sampling face of the body is preferably planar.

The reflective face is positioned relative to the source such that a longitudinal wave emanating from the source and impinging upon the reflective face is reflected to produce both a reflected longitudinal wave and a reflected horizontally polarised shear wave, the shear wave being horizontally polarised with reference to the reflective face. The sampling face is positioned relative to the reflective face such that the shear wave emanating therefrom is vertically polarised with reference to the sampling face. The sampling face is preferably positioned such that the shear wave emanating from the reflective face impinges upon the sampling face at a relatively shallow angle, with the result that the shear wave is reflected therefrom.

The body may further comprise a return reflective face adapted to reflect the wave reflected from the sampling face. In one embodiment the return reflective face may reflect the shear wave back among the same path form which it was received. In an alternative embodiment the return reflective face may reflect the shear wave along a different path. In an alternative embodiment the body may be provided with two or more sampling faces.

The body preferably comprises a material having both a low acoustic impedance and low ultrasonic attenuation. Preferably the material characteristics of the body are uniform. The body may comprise a plastics material such as, for example, cross-linked polystyrene. The body is preferably provided with external acoustic absorption means adapted to absorb unwanted ultrasonic waves. The source and receiver may be embodied by separate components. In an alternative embodiment the source and receiver may comprises a single component.

According to a further aspect of the present invention there is provided a method measuring the viscosity of a liquid, the method comprising the steps of:
providing a sensor comprising an ultrasonic source, a sampling body and an ultrasonic receiver, the sampling body including a sampling face,
placing the sampling face into contact with a liquid,
operating the source to generate a longitudinal ultrasonic wave which propagates through the body to the sampling face and onwards to the receiver,
transforming the longitudinal wave into a horizontally polarised shear wave prior to reaching the sampling face,
retransforming the horizontally polarised shear wave back to a longitudinal wave between the sampling face and the receiver; and
comparing the longitudinal wave received by the receiver with the longitudinal wave generated by the source to ascertain viscosity of the liquid.

An embodiment of the present invention will now be described with reference to the accompanying drawings in which:

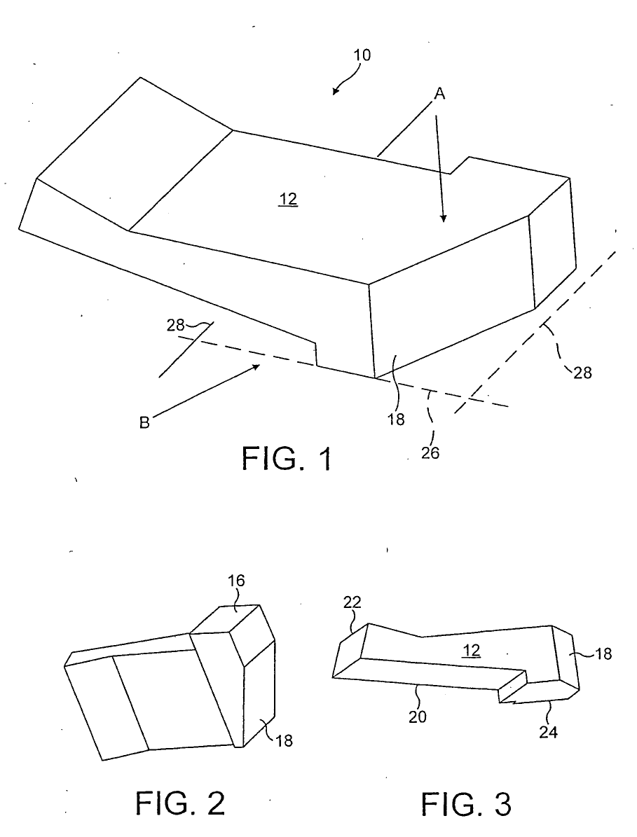

FIG. 1 shows a perspective view from above and to one side of a body forming part of the present invention;

FIGS. 2 and 3 show alternative perspective views of the body of FIG. 1;

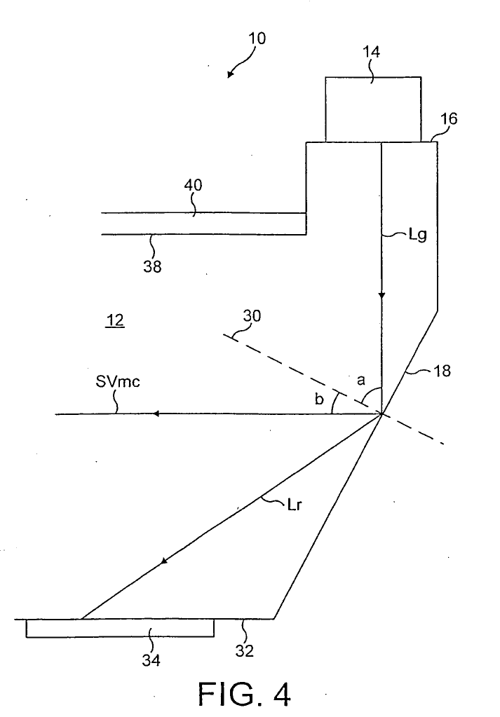

FIG. 4 shows a diagrammatic view of a portion of the body and an ultrasonic transducer as indicated by arrow A of FIG. 1 and showing the path of ultrasonic waves generated by the transducer;

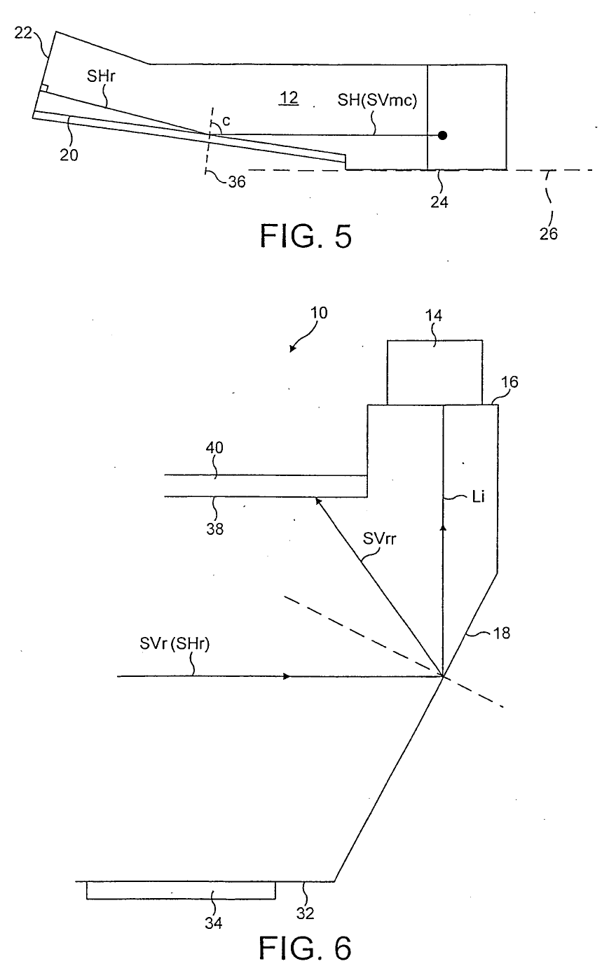

FIG. 5 shows a diagrammatic view of a portion of the body and an ultrasonic transducer as indicated by arrow A of FIG. 1 and showing the path of reflected ultrasonic waves received by the transducer;

FIG. 6 shows an edge view of the body as indicated by arrow B of FIG. 1;

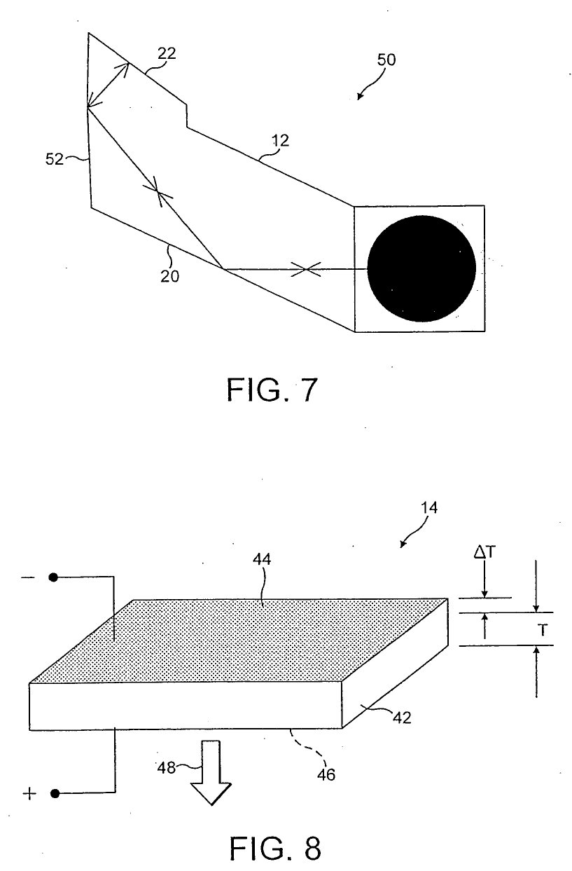

FIG. 7 shows a schematic view of an alternative embodiment of a body according to the present invention; and

FIG. 8 shows a simplified diagrammatic view of an ultrasonic transducer.

Referring to the figures there is shown a viscosity sensor apparatus generally designated 10 comprising a sampling body 12 and an ultrasonic transducer 14 acoustically coupled to a face 16 thereof. The body 12 is comprised of a block of material having both low acoustic impedance and low ultrasonic attenuation. The material may be a plastics material such as, for example, a cross linked polystyrene. The body 12 has a relatively complex shape with a number of faces. In the embodiment shown the body 12 takes the form of a dodecahedron having twelve differently shaped faces. The body 12 includes a transducer engagement face 16, a primary reflection face 18, a sampling face 20 and a return reflection face 22.

The transducer 14 is a longitudinal wave ultrasonic transducer. In the embodiment shown, there is provided a single transducer 14 adapted to both generate and receive ultrasound. It will be appreciated that an alternative embodiment of the invention may incorporate separate generation and reception transducers, and the constructional aspects of such an embodiment will be discussed in greater detail below. An example of a transducer 14 suitable for use in connection with the present invention is shown in FIG. 8. The transducer 14 essentially comprises a body of piezoelectric material 42 of which opposing sides have been coated with a conductive metal film or paint to form electrodes 44,46. Upon experiencing a voltage difference across the electrodes 44,46, the body 42 changes in thickness and consequently exerts a force, in the direction indicated by arrow 48, upon any medium which the body 42 may be in contact. It will be appreciated that the illustration of FIG. 8 is greatly simplified and that the actual transducer 14 includes additional components such as, for example, a backing material which ensures that the force 48 exerted by the body 42 is orientated in a predetermined direction. It will further be appreciated that the transducer 14 may be configured so as to operate in reverse such that force applied to the body 42 is converted into an electrical signal representative of said force.

In describing the orientation of the aforementioned faces 16, 18, 20, 22 to one another reference will be made to a reference plane on which a base face 24 of the body 12 lies. The reference plane is illustrated by broken line 26 on FIG. 5 and the broken lines 26 and 28 of FIG. 1. Both the transducer engagement and primary reflection faces 16,18 are perpendicular to the reference plane with the reflection face 18 being inclined relative to the transducer face 16. The inclination angle of the transducer and reflection faces 16, 18 is chosen so as to permit the propagation of ultrasonic waves within the body 12 in a predetermined fashion as will be described in greater detail below.

Looking now at the sampling and return reflection faces 20, 22, it will be noted that both of these are inclined relative to the reference plane. The sampling face 20 is inclined at a relatively shallow angle, while the return reflection face 22 is inclined at a relatively steep angle. Again the inclination of the respective faces 20, 22 is chosen so as to permit the propagation of ultrasonic waves within the body 12 in a predetermined fashion.

Operation of the apparatus 10 will now be described. Firstly, a liquid, for example oil, is brought into contact with the sampling face 20. The block 12 may, for example, be incorporated into a liquid reservoir, with the sampling face forming a portion of the reservoir wall. The transducer 14 is then operated to produce a longitudinal wave Lg directed towards the primary reflection face 18 as shown in FIG. 4. The wave L_{g} impinges on the face 18 at an angle a to the face normal 30 and produces a reflected longitudinal wave Lr and a mode converted vertically polarised shear wave SVmc. The propagation direction of the reflected longitudinal wave Lr is different to that of the shear wave SVmc as the two mode types have different propagation velocities. The actual directions of the reflected waves are governed by Snell's Law. The impingement angle a of the longitudinal wave Lg is selected to so as to maximise the generation of the shear wave SVmc. In an exemplary embodiment the impingement angle a may be 65 degrees which results in a reflected wave Lr at the same angle to the normal 24 and a shear wave SVmc reflected at an angle b of 25 degrees. It will be appreciated that the propagation direction of the shear wave is substantially parallel to the plane of the transducer engagement face 16. The reflected longitudinal wave Lr is directed towards a face 32 of the block 12 having an ultrasonic absorber layer 34 which, as its name suggests, absorbs the wave Lr.

Looking now to FIG. 5, there is shown the subsequent path of the shear wave. It will be appreciated that the view of FIG. 5 is substantially perpendicular to the view shown in FIG. 4. Thus the vertically polarised shear wave of FIG. 4 may be considered in the view shown in FIG. 5 to be a horizontally polarised shear wave SH with reference to the sampling face 20 it now approaches. The shear wave SH impinges upon the sampling face 20 at a shallow angle c. In an exemplary embodiment the angle may be 80 degrees to the plane normal 36. The shallow nature of the angle c ensures that no mode conversion of the incident shear wave SH occurs at the solid/liquid boundary present at the sampling face 20. The wave, now indicated SHr is reflected away from the sampling face 20 at the same angle and subsequently impinges perpendicularly upon the return reflection face 22. The wave SHr is then reflected back along the same path.

Referring now to FIG. 6 there is shown the return path of the reflected horizontally polarised shear wave. Due to the rotation of the view the reflected wave may be considered to be a vertically polarised shear wave SVr with reference to the reflection face 18 it is now approaching. Upon impinging upon the reflection face 18, the reflected wave SVr undergoes a similar transformation to that described with reference to FIG. 4. A portion of the energy of the wave SVr is reflected as a vertically polarised shear wave SVrr, while the remainder mode converts into a longitudinal wave Li. The geometry of the reflection face 18 ensures that the longitudinal wave Li is directed to the transducer 14, while the shear wave SVrr is directed to a further face 38 of the body 12 provided with an acoustic absorber 40.

The reflectivity of the at the solid liquid interface at the sampling face 20 is dependent upon the viscosity of the liquid. Thus by measuring the intensity of the reflected wave Li received back at the transducer 14, then a measurement of liquid viscosity can be made.

While the above described embodiment utilises a single transducer, it will be appreciated that the apparatus may be provided with separate transducers to generate and receive the ultrasonic waves. In such an embodiment the body is advantageously configured such that the wave reflected from the return reflection face 22 does not retrace the same path used to reach said face. In such an embodiment the separate transducers may be sited adjacent one another. FIG. 7 shows an illustrative example of an alternative embodiment of a sensor apparatus, generally designated 50, according to the present invention. The apparatus 50 differs from the previously described embodiment in that the body 12 is provided with two sampling faces 20, 52.

1. A liquid viscosity sensor comprising an ultrasonic source, a sampling body and an ultrasonic receiver, the sampling body including a sampling face contactable by a sample of liquid, in use, the source being operable to generate a longitudinal ultrasonic wave which follows a path through the body to the sampling face and onwards to the receiver, wherein the body is configured such that the longitudinal wave emanating from the source is transformed into a horizontally polarized shear wave prior to reaching the sampling face, and the horizontally polarized shear wave is re-transformed into a longitudinal wave before reaching the receiver.

2. A viscosity sensor as claimed in claim 1, wherein the sampling body is provided with a feature about which transformation of the waves occurs.

3. A viscosity sensor as claimed in claim 2, wherein the feature comprises a reflection point of the body.

4. A viscosity sensor as claimed in claim 2 wherein the feature comprises a reflective face of the body.

5. A viscosity sensor as claimed in claim 4, wherein the reflective face is substantially planar.

6. A viscosity sensor as claimed in claim 4, wherein the reflective face is defined by a solid to air interface of the body.

7. A viscosity sensor as claimed in claim 4, wherein the feature includes a reflective face positioned relative to the source such that a longitudinal wave emanating from the source and impinging upon the reflective face is reflected to produce both a reflected longitudinal wave and a reflected horizontally polarized shear wave, the shear wave being horizontally polarized with reference to the reflective face,

8. A viscosity sensor as claimed in claim 4, wherein the sampling face is positioned relative to the reflective face such that the shear wave emanating therefrom is vertically polarized with reference to the sampling face.

9. A viscosity sensor as claimed in claim 4, wherein the sampling face is positioned such that the shear wave emanating from the reflective face impinges upon the sampling face at a relatively shallow angle, with the result that the shear wave is reflected therefrom,

10. A viscosity sensor as claimed in claim 1, wherein the body further comprises a return reflective face to reflect the wave reflected from the sampling face.

11. A viscosity sensor as claimed in claim 10, wherein the return reflective face is arranged to reflect the shear wave back among the same path form which it was received,

12. A viscosity sensor as claimed in claim 10, wherein the return reflective face is arranged to reflect the shear wave along a different path from which it was received.

13. A viscosity sensor as claimed in claim 1, wherein the body comprises a material having a low acoustic impedance and low ultrasonic attenuation.

14. A viscosity sensor as claimed in claim 13, wherein the material characteristics of the body are uniform.

15. A viscosity sensor as claimed in claim 13, wherein the body comprises a plastics material.

16. A viscosity sensor as claimed in claim 15, wherein the body comprises cross-linked polystyrene.

17. A viscosity sensor as claimed in claim 1, wherein the body is provided with external acoustic absorption means to absorb unwanted ultrasonic waves.

18. A viscosity sensor as claimed in claim 1, wherein the source and receiver are embodied by separate components.

19. A viscosity sensor as claimed in claim 1, wherein the source and receiver comprise a single component.

20. A method measuring the viscosity of a liquid, the method comprising the steps of:
providing a sensor comprising an ultrasonic source, a sampling body and an ultrasonic receiver, the sampling body including a sampling face;
placing the sampling face into contact with a liquid;
operating the source to generate a longitudinal ultrasonic wave which propagates through the body to the sampling face and onwards to the receivers;
transforming the longitudinal wave into a horizontally polarized shear wave prior to reaching the sampling face;
retransforming the horizontally polarized shear wave back to a longitudinal wave between the sampling face and the receiver; and
comparing the longitudinal wave received by the receiver with the longitudinal wave generated by the source to ascertain viscosity of the liquid.
